(19) United States
(12) Patent Application Publication
(10) Pub. No.: US 2016/0237809 A1
(43) Pub. Date: Aug. 18, 2016

(54) Downhole Tool Non Contact Position Measurement System

(71) Applicant: Schlumberger Technology Corporation, Sugar Land, TX (US)

(72) Inventors: Julien Toniolo, Houston, TX (US); Alan J. Sallwasser, Houston, TX (US); Peter Wells, Houston, TX (US); Mark A. Fredette, Houston, TX (US)

(21) Appl. No.: 14/624,368

(22) Filed: Feb. 17, 2015

(51) Int. Cl. E21B 47/09; G01V 3/26; G01V 11/00; E21B 47/06

(52) U.S. Cl. CPC E21B 47/09; E21B 47/06; E21B 47/0905; G01V 3/26; G01V 11/002

(57) ABSTRACT

A downhole tool includes a position system. The position system includes a hub moveably coupled to a fixed tool string. The hub includes a sensor component. The position system also includes a position sensor disposed within the fixed tool string and segregated from the sensor component. Additionally, the sensor component is at a first pressure and the position sensor is at a second pressure, different than the first pressure.

### BACKGROUND

This disclosure relates generally to the field of downhole tools and, more particularly, to systems and methods for determining a position of a hub on a downhole tool.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions.

In hydrocarbon drilling operations, downhole tools may be lowered into a borehole to perform specific tasks. For example, a logging string system may be lowered through a drill string or downhole tubular. The logging string system includes a logging tool that takes various measurements, which may range from measurements such as pressure or temperature to advanced measurements such as rock properties, fracture analysis, fluid properties in the borehole, or formation properties extending into the rock formation. Some logging tools contact the borehole wall to obtain various measurements.

The logging tool may include mechanical linkages and components to facilitate expansion of the logging tool after the logging tool passes through the drill string or downhole tubular. The mechanical linkages are exposed to borehole pressures, as well as fluids having high viscosities or particulates. The borehole environment may degrade the linkages of the logging tool, thereby resulting in more frequent repairs or replacements.

### SUMMARY OF DISCLOSED EMBODIMENTS

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a downhole tool includes a position system. The position system includes a hub moveably coupled to a fixed tool string. The hub includes a sensor component. The position system also includes a position sensor disposed within the fixed tool string and segregated from the sensor component. Additionally, the sensor component is at a first pressure and the position sensor is at a second pressure, different than the first pressure.

In another embodiment, a logging tool may be disposed in a borehole. The logging tool includes a linkage-less caliper tool that moves radially relative to the logging tool. The logging tool also includes a position system that detects a radial position of the caliper tool.

In a further embodiment, a method for determining a radial position of a caliper tool includes inducing movement of a hub coupled to the caliper tool. The hub moves in response to radial movement of the caliper tool. The method also includes generating a signal indicative of a hub position via a position sensor. The method further includes determining the radial position of the caliper tool based on the signal indicative of the hub position.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended just to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 shows a schematic view of an embodiment of a drilling system, in accordance with various embodiments of the present disclosure;

FIG. 2 shows a perspective view of an embodiment of a logging tool having a caliper tool, in accordance with various embodiments of the present disclosure;

FIG. 3 shows a block diagram of an embodiment of a control system, in accordance with various embodiments of the present disclosure;

FIG. 4 shows a partial schematic cross-sectional view of an embodiment of a position system having a magnetoresistive system in a first position, in accordance with various embodiments of the present disclosure;

FIG. 5 shows a partial schematic cross-sectional view of the position system of FIG. 4 in a second position, in accordance with various embodiments of the present disclosure;

FIG. 6 shows a partial schematic cross-sectional view of an embodiment of a position system having a linear variable differential transformer in a first position, in accordance with various embodiments of the present disclosure;

FIG. 7 shows a partial schematic cross-sectional view of the position system of FIG. 6 in a second position, in accordance with various embodiments of the present disclosure;

FIG. 8 shows a partial schematic cross-sectional view of an embodiment of a position system having a partial reflective system in a first position, in accordance with various embodiments of the present disclosure;

FIG. 9 shows a partial schematic cross-sectional view of the position system of FIG. 8 in a second position, in accordance with various embodiments of the present disclosure; and

FIG. 10 shows a flow chart of an embodiment of a method for determining the radial position of a caliper tool, in accordance with various embodiments of the present disclosure.

### DETAILED DESCRIPTION

One or more specific embodiments of the present disclosure will be described below. These described embodiments are just examples of the presently disclosed techniques. Additionally, in an effort to provide a concise description of these embodiments, some features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would still be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure are directed toward systems and methods for determining a position of a hub on a downhole tool. In some cases, the axial position of the hub may correspond to a radial position of a mechanical caliper. In examples where the downhole tool includes a caliper, the caliper may include a moveable hub that axially moves along a logging tool as the radial position of the calipers changes. Moreover, the logging tool may include a position sensor to interact with the hub to generate a signal indicative of the axial position of the hub. In certain embodiments, the position sensor includes an array of magnetoresistive sensors that interact with a magnet in the hub. Additionally or alternatively, the position sensor may include a linear variable differential transformer that generate a differential voltage because of the hub position along the logging tool. Moreover, the position sensor may, in certain examples, include a reflective sensor that receive a signal and send a reflected signal back toward a source.

As noted above, the axial position of the hub may correspond to a radial position of a mechanical caliper. It should be appreciated, however, that the systems and methods for determining the position of the hub may be used in downhole tools that do not include a caliper, but use the position of the hub in other ways (e.g., an anchoring device, a centralizer, a fishing tool).

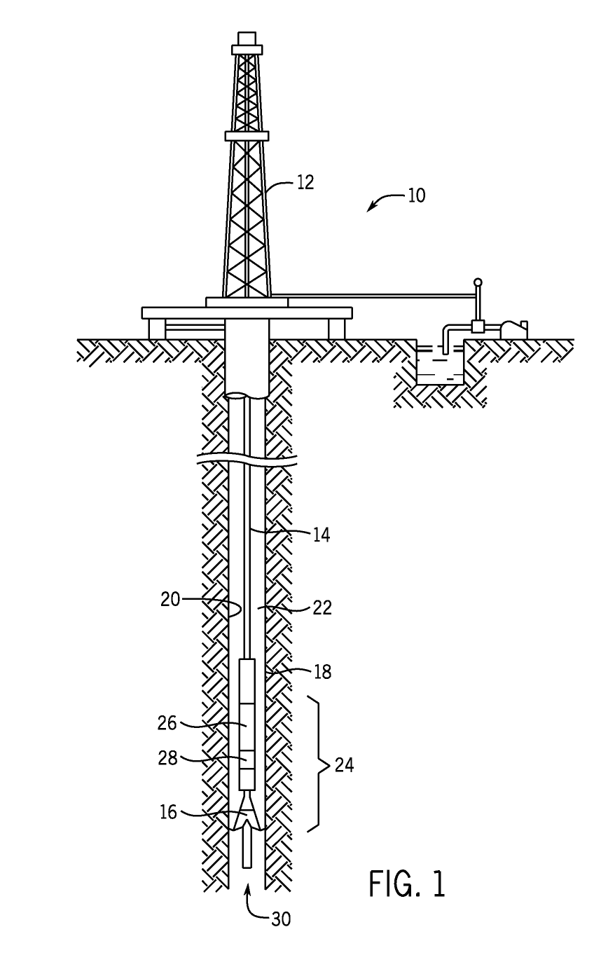

Referring now to FIG. 1, an embodiment of a downhole drilling system 10 (e.g., drilling system) comprises a rig 12 and a drill string 14 coupled to the rig 12. The drill string 14 includes a drill bit 16 at a distal end that may be rotated to engage a formation and form a borehole 18. As shown, the borehole 18 includes a borehole sidewall 20 (e.g., sidewall) and an annulus 22 between the borehole 18 and the drill string 14. Moreover, a bottom hole assembly (BHA) 24 is positioned at the bottom of the borehole 18. The BHA 24 may include a drill collar 26, stabilizers 28, or the like.

During operation, drilling mud or drilling fluid is pumped through the drill string 14 and out of the drill bit 16. The drilling mud flows into the annulus 22 and removes cuttings from a face of the drill bit 16. Moreover, the drilling mud may cool the drill bit 16 during drilling operations. In the illustrated embodiment, the drilling system 10 includes a logging tool 30. As shown, the logging tool 30 may extend through the drill bit 16. The logging tool 30 may conduct downhole logging operations to obtain various measurements in the borehole 18. For example, the logging tool 30 may include sensors (e.g., resistive, nuclear, photonic, seismic, etc.) to determine various borehole and/or fluidic properties. Additionally, the logging tool 30 may include sampling tools to obtain core samples, fluid samples, or the like from the borehole 18. Moreover, in certain embodiments, the logging tool 30 may include mechanical measurement devices, such as calipers, to obtain measurements of the borehole 18.

The logging tool 30 may conduct downhole operations while the drill string 14 is positioned within the borehole 18 and while the drill string 14 is being removed from the borehole 18. For example, the logging tool 30 may be extended through the drill bit 16 and being logging operations. Then, the drill string 14 may be removed from the borehole 18 while the logging tool 30 is extended through the drill bit 16. While the illustrated embodiment includes a substantially vertical borehole 18, in other embodiments the borehole 18 may be deviated or substantially horizontal. Additionally, while the illustrated example includes the logging tool 30 extending from the drill bit 16, in other embodiments, the logging tool 30 may be a separate sub coupled to the drill string 14.

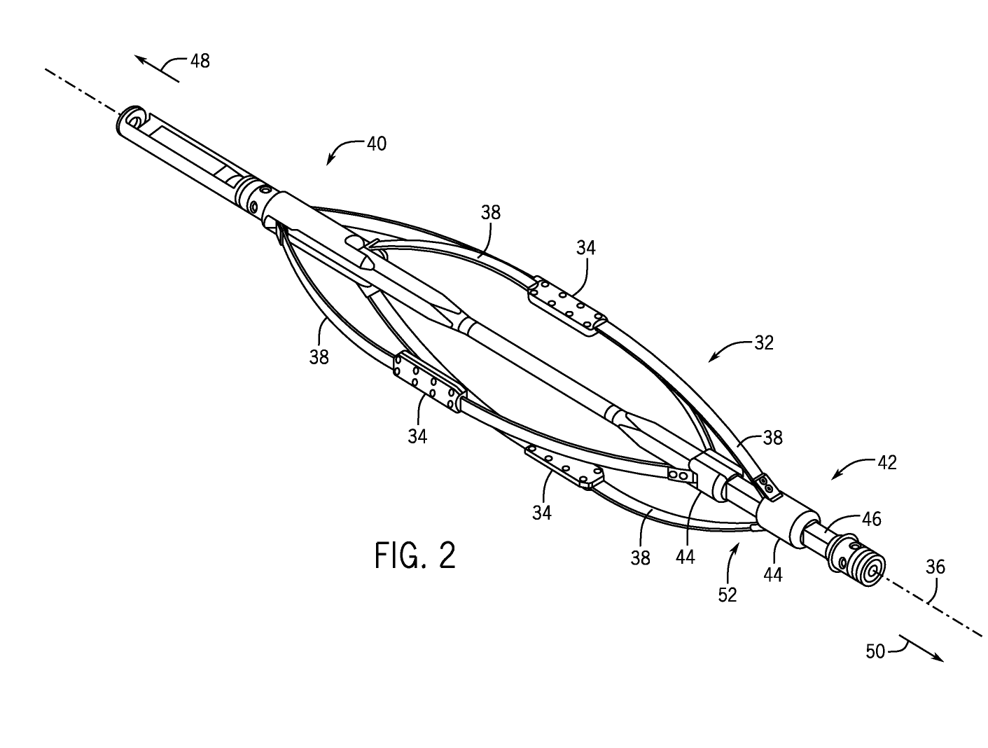

FIG. 2 shows an isometric view of an example of the logging tool 30. In the illustrated example, the logging tool 30 includes mechanical calipers 32 (e.g., calipers) and sensors 34. In certain embodiments, the calipers 32 are that expand radially with respect to a logging tool axis 36. The calipers 32 may contact the sidewall 20 of the borehole 18 to obtain various measurements. For example, the calipers 32 may be used to determine the diameter of the borehole 18. Additionally, in certain embodiments, the calipers 32 may press the sensors 34 against the sidewall 20 of the borehole 18, thereby enabling additional measurements (e.g., resistivity, nuclear, photonic, seismic, etc.) of the formation. However, in other embodiments, the sensors 34 may be non-contact sensors and may not contact the sidewall 20 of the borehole 18 to obtain formation measurements.

In the illustrated embodiment, the calipers 32 include springs 38 that drive the calipers 32 radially outward with respect to the logging tool axis 36. That is, the springs 38 are biased to enable expansion of the calipers 32 after the logging tool 30 is extended through the drill bit 16. However, in other embodiments, the calipers 32 may include mechanical actuators to facilitate deployment of the calipers 32. For example, the mechanical actuators may block expansion of the calipers 32 until activated. In embodiments where the logging tool 30 extends through the drill bit 16, the mechanical actuators may block deployment of the calipers 32 until the logging tool 30 is through the drill bit 16.

As shown, the calipers 32 are coupled to the logging tool 30 at a first location 40 and at a second location 42. The first location 40 is axially farther up the borehole 18 (e.g., closer to the surface) than the second location 42. As will be described below, the first location 40 may be rigidly fixed to the logging tool 30. Moreover, the second location 42 may be that move and/or slide axially along the logging tool axis 36. For example, the second location 42 may be positioned on a hub 44 (e.g., a moveable member) positioned radially about a tool string 46 (e.g., a shaft, a fixed member) of the logging tool 30.

The hub 44 may slide along the tool string 46 in response to the radial expansion and/or compression of the calipers 32. In certain embodiments, the hub 44 includes rollers, bearings, or the like to facilitate axial movement along the tool string 46. For example, radial expansion of the calipers 32 drives the hub 44 in a first direction 48 along the logging tool axis 36 (e.g., toward the first location 40, toward the surface). Additionally, radial compression of the calipers 32 drives the hub 44 in a second direction 50 along the logging tool axis 36 (e.g., away from the first location 40, toward the bottom of the borehole 18). As will be described in detail below, the axial movement of the hub 44 along the logging tool axis 36 may be used to determine the radial position of the calipers 32 via a position system 52.

In the illustrated embodiment, four calipers 32 are coupled to two hubs 44. As shown, the calipers 32 are positioned approximately 90 degrees offset from the adjacent calipers 32. As a result, four measurements may be obtained indicative of the radius of the borehole 18. However, in other embodiments, more or fewer calipers 32 may be utilized. For example, 2, 3, 5, 6, 7, 8, or any suitable number of calipers 32 may be positioned on the tool string 46 to obtain borehole measurements. Moreover, in the illustrated embodiment, each hub 44 is coupled to two calipers 32, facilitating multiple independent measurements of the borehole 18. However, in other embodiments, more of fewer hubs 44 may be utilized. For example, each caliper 32 may be independently coupled to a single hub 44.

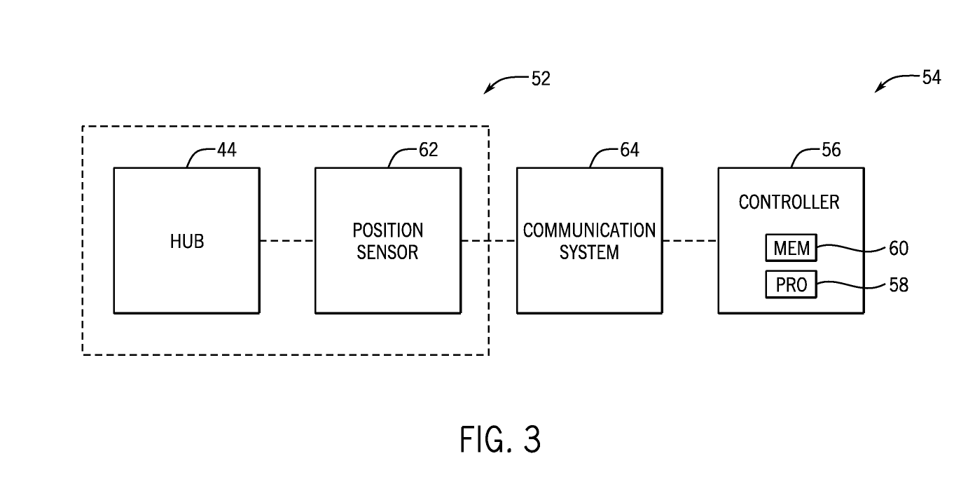

FIG. 3 is a block diagram of an embodiment of a control system 54 that determine the radial position of the calipers 32 relative to the logging tool axis 36. The control system 54 includes a controller 56 having a processor 58 and a memory 60. The memory 60 may include one or more non-transitory (i.e., not merely a signal), computer-readable media, which may include executable instructions that may be executed by the processor 58. The controller 56 receives a signal from the position system 52 indicative of a position of the hub 44 along the tool string 46. For example, the position system 52 may include a position sensor 62 that interacts with the hub 44 (e.g., wirelessly, electrically, magnetically, etc.) to determine the position of the hub 44 on the tool string 46.

In the illustrated embodiment, the position system 52 is communicatively coupled to a communication system 64. The communication system 64 may send a signal to the surface (e.g., to a surface controller) indicative of the radial position of the calipers 32. In certain embodiments, the communication system 64 includes a telemetry system, a wireless transceiver, a wired communication line (e.g., Ethernet, fiber optic, etc.), or the like to transmit data from the logging tool 30 to the surface. Moreover, the communication system 64 may include a wired or wireless transceiver to receive and/or transmit data between the logging tool 30 and the position system 52 and/or the sensors 34. The communication system 64 sends the signal to the controller 56 to coordinate drilling, completion, and/or cementing operations.

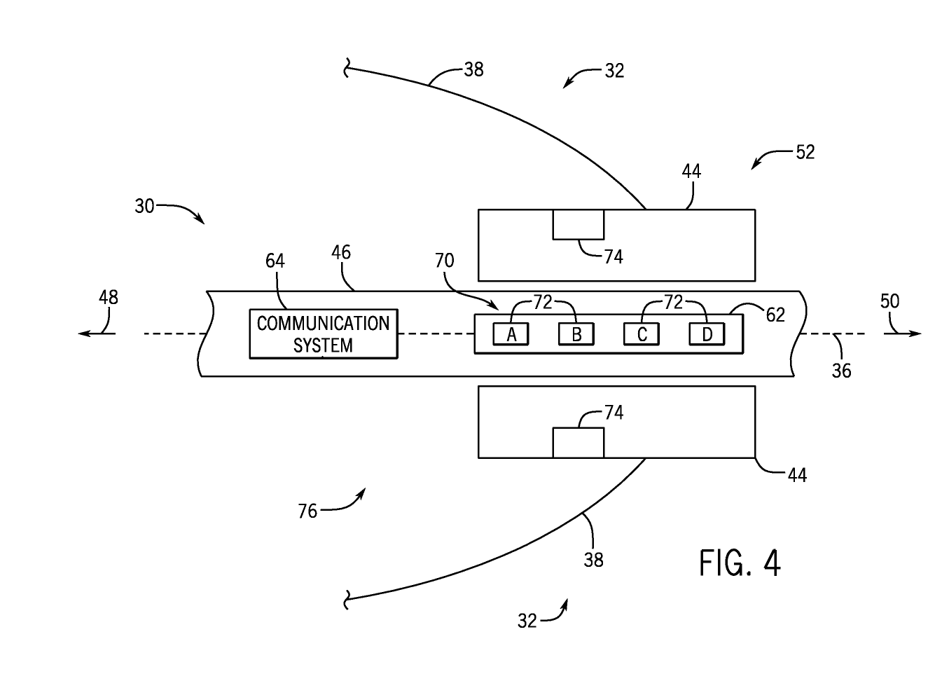

FIG. 4 is a partial schematic cross-sectional view of an embodiment of the position system 52 positioned along the logging tool 30. In the illustrated embodiment, the position system 52 includes the hub 44 and the position sensor 62. The position system 52 is communicatively coupled to the communication system 64, as described above, to transmit data indicative of the position of the hub 44 on the tool string 46. In the illustrated embodiment, the position sensor 62 includes an array 70 of magnetoresistive sensors 72. While the illustrated embodiment includes four magnetoresistive sensors 72, in other embodiments the array 70 may include 1, 2, 3, 5, 6, 7, 8, 9, 10, or any suitable number of magnetoresistive sensors 72. Additionally, because the magnetoresistive sensors 72 are disposed within the tool string 46, they may be at a pressure (e.g., a second pressure) substantially equal to atmospheric pressure. In other words, the magnetoresistive sensors 72 may be substantially isolated from the borehole pressure. Moreover, a magnet 74 is positioned within the hub 44. However, in other embodiments, the magnet 74 may be positioned on the hub 44 and be exposed to borehole pressure (e.g., a first pressure). In certain embodiments, the magnet 74 may be an electromagnetic that transmits a magnetic field toward the array 70. However, in other embodiments, the magnet 74 may be a permanent or temporary magnet. The magnetoresistive sensors 72 may change a value of electrical resistance in response to the magnetic field transmitted by the magnet 74. However, as shown, the magnet 74 and the array 70 are segregated from one another. Accordingly, as the hub 44 moves along the hub 44 in the first direction 48 and the second direction 50, the electrical resistance of the magnetoresistive sensors 72 will change relative to the position of the hub 44.

In the illustrated embodiment, the hub 44 is in a first position 76. In the first position 76, the magnet 74 is interacting with the magnetoresistive sensor 72b. In other words, the magnetic field transmitted by the magnet 74 is changing the electrical resistance of the magnetoresistive sensor 72b (e.g., based on resistance measured across the magnetoresistive sensor 72b). As a result, the position sensor 62 may send a signal to the communication system 64 indicative of the changed resistance of the magnetoresistive sensor 72b. Accordingly, the controller 56 may determine the position of the hub 44. For example, the magnetoresistive sensor 72b may correspond to a location on the tool string 46. Moreover, the position of the hub 44 may correspond to a radial position of the caliper 32. That is, the caliper 32 may be calibrated to associate different hub positions with associated radial positions of the calipers 32.

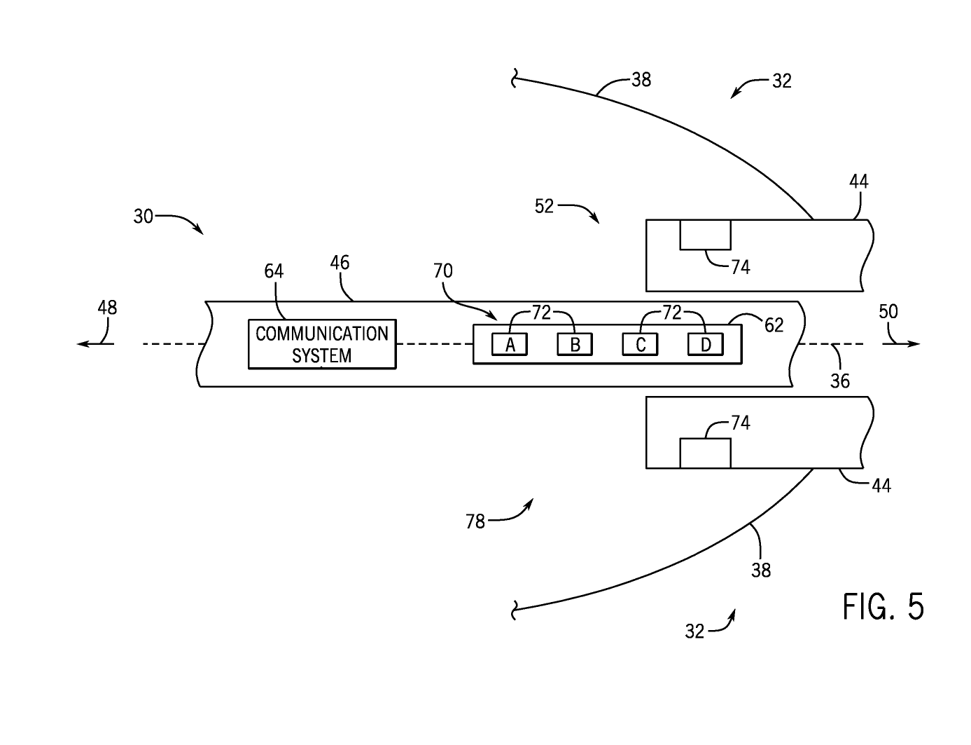

FIG. 5 is a partial schematic cross-sectional view of an embodiment of the position system 52, in which the hub 44 is in a second position 78. As described above, the magnet 74 in the hub 44 may interact with the magnetoresistive sensors 72 of the array 70. In the second position 78, the hub 44 moves in the second direction 50 axially along the logging tool axis 36, relative to the first position 76. For example, the calipers 32 may be radially compressed (e.g., due to contact with the sidewall 20), thereby driving the hub 44 in the second direction 50. As a result, the magnet 74 interacts with the magnetoresistive sensor 72d. As mentioned above, the position of the magnetoresistive sensor 72d may correspond to a radial position of the calipers 32. Accordingly, the radial position of the calipers 32 may be determined as the axial position of the hub 44 changes.

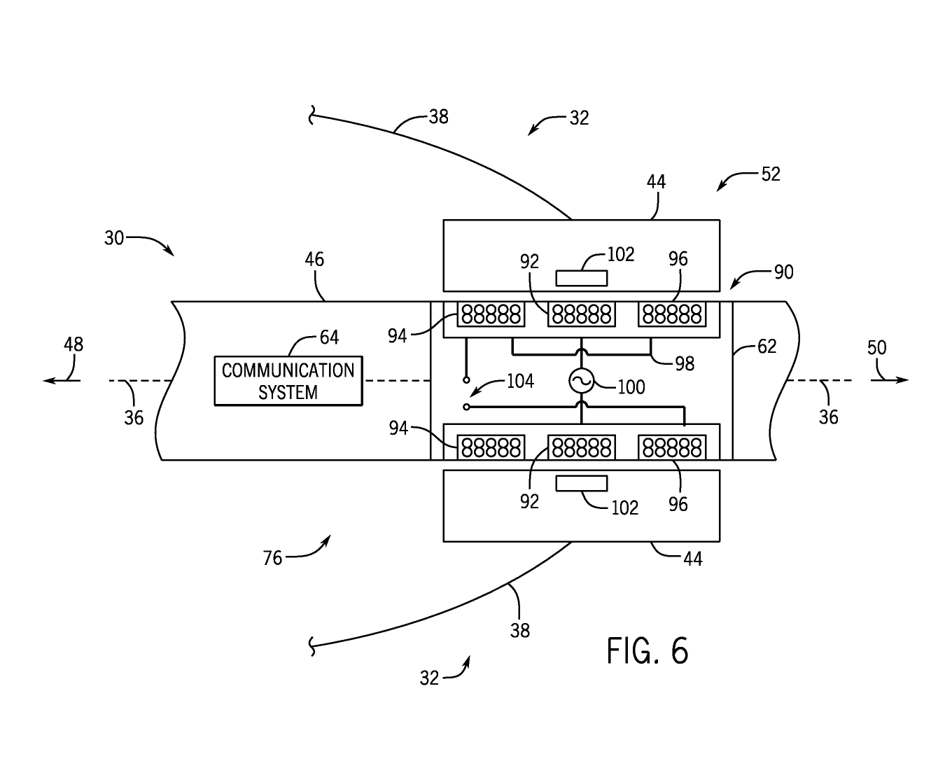

FIG. 6 is a partial schematic cross-sectional view of an embodiment of the position sensor 62 positioned along the logging tool 30. As described above, the hub 44 is positioned about the tool string 46 and may move in the first direction 48 and the second direction 50 along the logging tool axis 36. In the illustrated embodiment, the position sensor 62 includes a linear variable differential transformer (LVDT) 90. The LVDT 90 includes a primary coil 92, a top secondary coil 94, and a bottom secondary coil 96. Each coil 92, 94, 96 is wrapped around the interior circumference of the tool string 46. As shown, the top secondary coil 94 and the bottom secondary coil 96 are electrically coupled via a connecting wire 98. Moreover, the primary coil 92 is electrically coupled to a power source 100 configured to supply an alternating current to induce a voltage in the top secondary coil 94 and the bottom secondary coil 96 as the hub 44 moves axially along the tool string 46. In the illustrated embodiment, the hub 44 includes a core 102 configured to induce a voltage across the top secondary coil 94 and the bottom secondary coil 96 which may be measured as a differential at a junction 104. While the illustrated embodiment 102 depicts the core 102 embedded within the hub 44, in other embodiments the hub 44 may be the core 102.

In operation, movement of the hub 44 in the first direction 48 and the second direction 50 may induce a voltage at the junction 104. For example, in the illustrated embodiment, the hub 44 is in the first position 76 and the core 102 is substantially aligned with the primary coil 92. As a result, the top secondary coil 94 and bottom secondary coil 96 produce substantially equal and opposite voltages, thereby correlating to a differential voltage at the junction 104 of substantially zero. However, movement of the core 102 may induce voltages having different values and/or poles from the top secondary coil 94 and the bottom secondary coil 96. As a result, the differential voltage at the junction 104 may substantially correspond to the position of the core 102 along the tool string 46. For example, as described above, the calipers 32 may be calibrated to associate a given differential voltage with the radial position of the calipers 32.

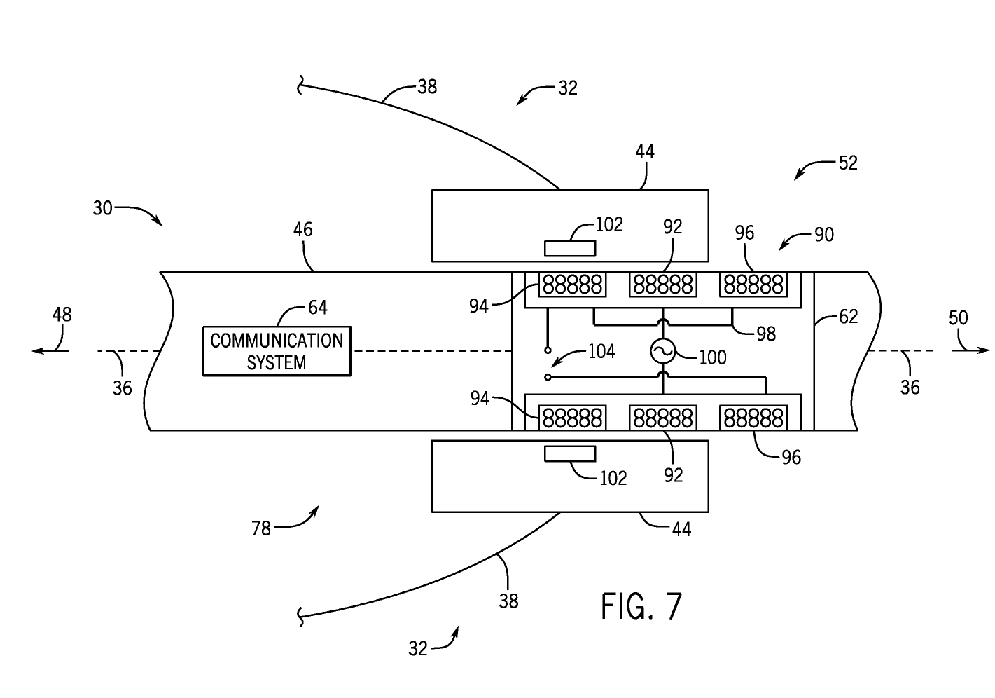

FIG. 7 is a partial schematic cross-sectional view of an embodiment of the position system 52 positioned along the logging tool 30. As mentioned above, the position system 52 includes the LVDT 90 having the primary coil 92, the top secondary coil 94, and the bottom secondary coil 96. In the illustrated embodiment, the hub 44 is moved in the first direction 48 along the logging tool axis 36 to the second position 78. For example, the calipers 32 may radially expand relative to the logging tool axis 36, thereby driving the hub 44 in the first direction 48. Because the core 102 moves with the hub 44, voltage in the top secondary coil 94 increases while voltage in the bottom secondary coil 96 decreases. Moreover, because the phase of the voltage across the top secondary coil 94 is the same as the phase of the voltage of the primary coil 92, the differential voltage measurement at the junction 104 may reveal that the hub 44 has moved in the first direction 48. Furthermore, movement in the second direction 50 would facilitate a larger voltage across the bottom secondary coil 96 having a phase opposite that of the primary coil 92. Accordingly, by measuring the differential voltage at the junction 104, the axial position of the hub 44 along the tool string 46 may be determined.

As mentioned above, the measured differential voltage at the junction 104 may be sent to the communication system 64. The communication system 64 may send the measure differential voltage to the controller 56 for processing. For example, the controller 56 may utilize data stored in the memory 60 to determine that the measured differential voltage correlates to an axial position of the hub 44 on the tool string 46, and therefore corresponds to the radial position of the calipers 32.

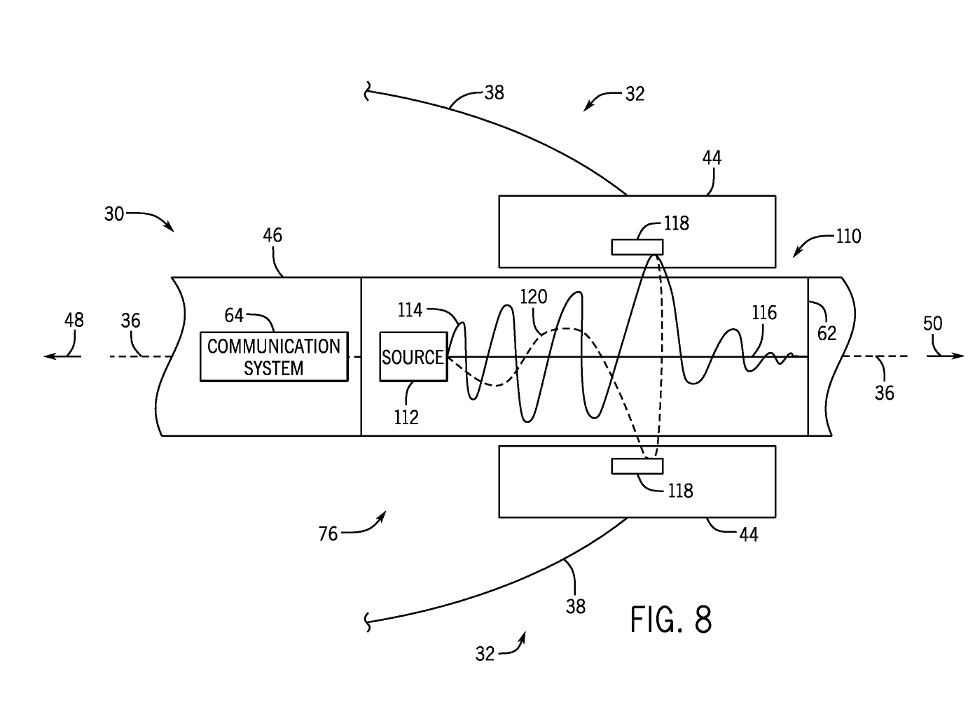

FIG. 8 is a partial schematic cross-sectional view of an embodiment of the position system 52 positioned along the logging tool 30. In the illustrated embodiment, the position sensor 62 includes a reflective sensor 110. The reflective sensor 110 includes a source 112 configured to transmit a signal 114 down a wire 116. For example, the signal 114 may be an electrical impulse. As shown, the hub 44 includes a reflector 118 embedded within the hub 44. For example, the reflector 118 may be a magnet configured to receive the signal 114 and reflect a reflected signal 120 back to the source 112. The source 112 may include a receiver configured to receive the reflected signal 120. In certain embodiments, the source 112 may include a timer configured to determine the time between emission of the signal 114 and reception of the reflected signal 120 to determine the axial position of the reflector 118. As will be appreciated, the axial position of the reflector 118 corresponds to the axial position of the hub 44.

In operation, the radial position of the calipers 32 drives the hub 44 axially along the logging tool axis 36 in the first direction 48 and the second direction 50. In the illustrated embodiment, the hub 44 is at the first position 76. As mentioned above, the first position 76 may correspond to the time elapsed between emitting the signal 114 and receiving the reflected signal 120, and thereby correspond to the radial position of the calipers 32 (e.g., via information stored in memory 60).

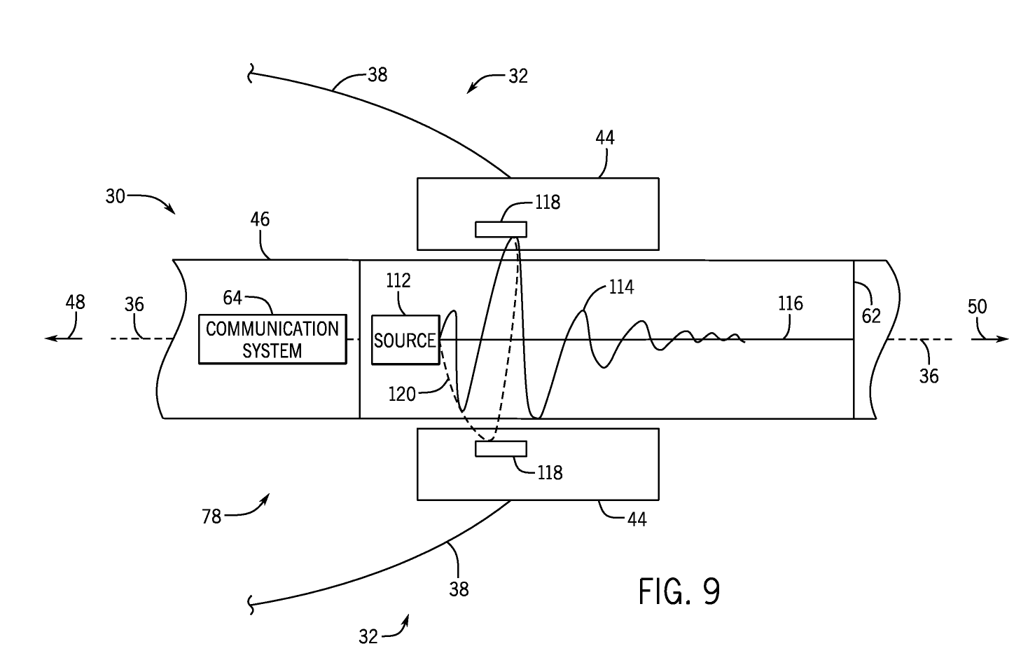

FIG. 9 is a partial schematic cross-sectional view of an embodiment of the position system 52 positioned along the logging tool 30. In the illustrated embodiment, the hub 44 is in the second position 78. In other words, the hub 44 moves axially along the logging tool axis 36 in the first direction 48. For example, the hub 44 may be driven in the first direction 48 by radial expansion of the calipers 32. As shown, the reflector 118 is positioned closer to the source 112 than while the hub 44 was in the first position 76. As a result, the time elapsed between emitting the signal 114 and receiving the reflected signal 120 is reduced, thereby indicating that the hub 44 is closer to the source 112. As mentioned above, the communication system 64 may send the elapsed time to the controller 56 to evaluate the position of the hub 44 based on the elapsed time. Accordingly, the axial position of the hub 44 may be utilized to determine the radial position of the calipers 32.

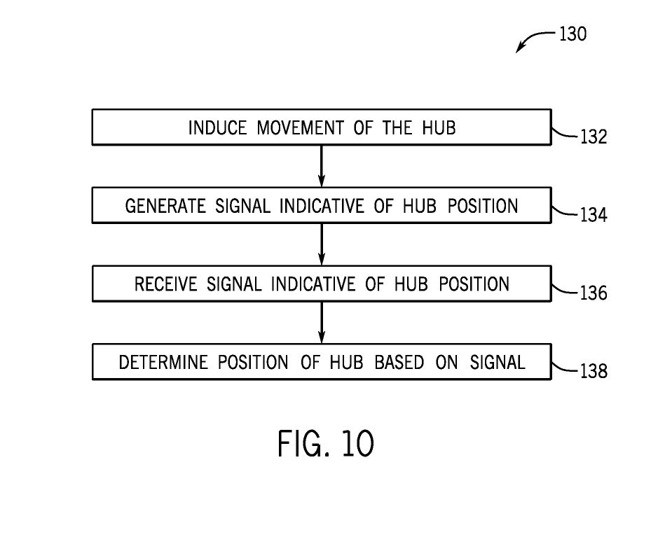

FIG. 10 is a flow chart of an embodiment of a method 130 for determining the radial position of the caliper 32. Movement of the hub 44 is induced at block 132. For example, the logging tool 30 may be extended through the drill bit 16 and into the borehole 18. The calipers 32 may be driven to radially expand via the springs 38. As mentioned above, the calipers 32 are coupled to the hub 44 and radial movement (e.g., expansion or compression) of the calipers 32 drives movement of the hub 44 along the logging tool axis 36. A signal indicative of the hub position may be generated at block 134. For example, the hub 44 may interact with the position sensor 62 to produce a signal indicative of the hub position. In certain embodiments, the magnet 74 in the hub 44 may interact with the magnetoresistive sensors 72. In other embodiments, the hub 44 may induce a differential voltage across the top secondary coil 94 and the bottom secondary coil 96. Moreover, in other embodiments, the hub 44 may send the reflected signal 120 back to the source 112. The signal may be received by the communication system and/or the controller 56 at block 136. For example, as described above, the communication system 64 may be communicatively coupled to the position sensor 62. Additionally, the communication system 64 may send the signal to the controller 56 for evaluation. The radial position of the calipers 32 is determined at block 138. For example, the controller 56 may evaluate the signal indicative of the position of the hub 44 via the processor 58 utilizing data stored on the memory 60. In certain embodiments, the position of the hub 44 corresponds to a radial position of the calipers 32. For example, the hub position may be compared to a calibrated hub position. As a result, the radial position of the calipers 32 may be determined based on the axial position of the hub 44 along the tool string 46.

As described in detail above, embodiments of the present disclosure are directed toward the position system 52 configured to determine the radial position of the calipers 32. For example, the position system 52 includes the hub 44 configured to move axially along the logging tool axis 36. Movement of the hub 44 corresponds to the radial position of the calipers 32. Moreover, the position system 52 includes the position sensor 62. In certain embodiments, the position sensor 62 includes the magnetoresistive sensors 72 configured to interact with the hub 44 to produce a signal indicative of the position of the hub 44. Additionally, in other embodiments, the position sensor 62 includes the LVDT 90 configured to generate a differential voltage based on the position of the hub 44. Furthermore, in other embodiments, the position sensor 62 includes the reflective sensor 110 configured to indicate the position of the hub 44 based on the time elapsed between the emission of the signal 114 and the reception of the reflected signal 120. The position of the hub 44 along the tool string 46 may correspond to the radial position of the calipers 32. As a result, the position of the hub 44 may be utilized to determine the radial position of the calipers 32.

The specific embodiments described above have been shown by way of example, and it should be understood that these embodiments may be susceptible to various modifications and alternative forms. It should be further understood that the claims are not intended to be limited to the particular forms disclosed, but rather to cover modifications, equivalents, and alternatives falling within the spirit and scope of this disclosure.

What is claimed is:

1. A downhole tool, comprising:
a position system, comprising:
a hub moveably coupled to a fixed tool string, wherein the hub comprises a sensor component; and
a position sensor disposed within the fixed tool string and segregated from the sensor component;
wherein the sensor component is at a first pressure and the position sensor is at a second pressure, different than the first pressure.

2. The downhole tool of claim 1, comprising a calipering feature coupled to the hub, wherein the position sensor is configured to emit a signal correlated to the caliper measurement.

3. The downhole tool of claim 1, wherein the position sensor comprises a magnetoresistive sensor, a linear variable differential transformer, a reflective sensor, or a combination thereof.

4. The downhole tool of claim 3, wherein the hub moves axially along the fixed tool string.

5. The downhole tool of claim 3, wherein the magnetoresistive sensor comprises an array, comprising:
a plurality of magnetoresistive sensors configured to change a respective resistance value in response to the axial position of the hub;
wherein the magnetoresistive sensors are configured to interact with a magnet positioned radially about the position sensor.

6. The downhole tool of claim 1, wherein the linear variable differential transformer comprises:
a primary coil electrically coupled to a power source;
a top secondary coil; and
a bottom secondary coil electrically coupled to the top secondary coil;
wherein the axial movement of the hub is configured to generate a differential voltage between the top secondary coil and bottom secondary coil.

7. The downhole tool of claim 1, wherein the reflective sensor comprises:
a source configured to generate a signal within the logging tool; and
a reflector positioned proximate to the position sensor, wherein the reflector is configured to receive the signal generated by the source and return a reflected signal back to the source.

8. The downhole tool of claim 1, comprising a controller configured to determine an axial position of the hub based on a signal generated by the position system.

9. The downhole tool of claim 1, comprising a logging tool stored within a drill string extending into the borehole, wherein the position system is coupled to the logging tool and the logging tool is configured to extend through a drill bit disposed on an end of the drill string.

10. The downhole tool of claim 10, wherein the logging tool is configured to make borehole measurements while the drill string is being removed from the borehole.

11. A logging tool configured to be disposed in a borehole, the logging tool comprising:
a linkage-less caliper tool configured to move radially relative to the logging tool; and
a position system configured to detect a radial position of the caliper tool.

12. The logging tool of claim 11, wherein the position system comprises:
a hub configured to move axially along a logging tool axis of the logging tool in response to radial movement of the linkage-less caliper tool; and
a position sensor configured to interact with the hub, wherein the position sensor is activated by axial movement of the hub.

13. The logging tool of claim 12, wherein the position sensor comprises a magnetoresistive sensor, a linear variable differential transformer, a reflective sensor, or a combination thereof.

14. The logging tool of claim 11, wherein the logging tool is configured to extend through a drill bit coupled to a drill string.

15. The logging tool of claim 11, comprising a communication system communicatively coupled to the position system, wherein the communication system is configured to send a signal indicative of the radial position of the caliper tool to a surface controller.

16. A method for determining a radial position of a caliper tool, comprising:
inducing movement of a hub coupled to the caliper tool, wherein the hub is configured to move in response to radial movement of the caliper tool;
generating a signal indicative of a hub position via a position sensor; and
determining the radial position of the caliper tool based on the signal indicative of the hub position.

17. The method of claim 16, comprising receiving the signal indicative of the hub position via a controller.

18. The method of claim 17, comprising sending the signal indicative of the hub position to the controller via a communication system communicatively coupled to the position sensor and to the controller.

19. The method of claim 16, comprising extending the caliper tool through a drill bit in a borehole.

20. The method of claim 16, wherein determining the radial position of the caliper tool based on the signal indicative of the hub position comprises comparing the hub position to a calibrated hub position.
